(19) United States
(12) Patent Application Publication
(10) Pub. No.: US 2006/0104289 A1
(43) Pub. Date: May 18, 2006

(54) Multiplexed computer peripheral connection switching interface

(75) Inventor: Chun-Liang Lee, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 10/988,307

(22) Filed: Nov. 12, 2004

(51) Int. Cl. H04L 12/56

(52) U.S. Cl. 370/400; 370/463

(57) ABSTRACT

A multiplexed computer peripheral connection switching interface is proposed, which is designed for use in conjunction with a clustered computer system that is equipped with a number of independent data processing units, such as a blade server with multiple server modules, for the multiple server modules in the blade server to share an external set of peripheral devices; and which is characterized by the use of the existing BMC (Baseboard Management Controller) management control module for control of the linking between a user-specified server module and a selected one of the peripheral devices. This feature allows multiple server modules in a blade server to share a group of peripheral devices in a more cost-effective and convenient way than prior art.

### BACKGROUND OF THE INVENTION

1. Field of the Invention

This invention relates to computer peripheral technology, and more particularly, to a multiplexed computer peripheral connection switching interface which is designed for use in conjunction with a clustered computer system that is equipped with a number of independent data processing units, such as a blade server with multiple server modules, for the multiple server modules in the blade server to share a group of peripheral devices, including, for example, a keyboard, a mouse, a display unit, and a data storage unit (such as a portable flash memory module).

2. Description of Related Art

Blade server is a clustering type of network server that is characterized by the use of a circuit board enclosure to integrate a cluster of server modules (commonly called “blades”), with all of these server modules providing the same server functionality. In other words, a blade server can respond to a client's request by linking any one of the clustered server modules to the client. In practical implementation, each server module is made into a single circuit-board (i.e., blade), which can be easily fitted to the blade server's enclosure to increase the blade server's client serving capacity. Moreover, a blade server is typically equipped with a common management control module for controlling all the operations of the multiple server modules and their shared resources in the blade server.

A computer platform is typically equipped with a dedicated set of peripheral input devices, such as keyboard and mouse, which allow the user to input data and commands to the computer platform in the operations of applications or system management tasks. In network applications, blade servers are used as Web servers, file servers, E-mail servers, and so on. In such applications, since peripheral input devices are required only in the setup stage and are unnecessary during the server operation, keyboard and mouse are typically removed to save equipment cost and room space. For this sake, blade servers are typically unequipped with keyboard and mouse during actual operation, and keyboard and mouse are externally coupled to blade servers only when it is necessary to perform system management tasks. Moreover, in practical application, a blade server may often need to be externally connected to an outside data storage unit, such as a USB (Universal Serial Bus) flash memory module or the like, for downloading new data into the blade server or make a backup copy to the outside data storage unit.

When it is required to perform some system management tasks on a blade server, such as doing system upgrades or maintenances, it is typically necessary to at least attach a display unit, a keyboard, and a mouse to the blade server so as to allow the system management personnel to operate the blade server via these peripheral devices.

One solution to the foregoing necessity is to utilize a KVM (keyboard/video/mouse) switch that allows the blade server to be externally connected to a keyboard, a video display unit, and a mouse. In addition, a KVM device is also capable of VGA/USB switching, which allows the blade server to switch between the connection to a VGA display unit and the connection to a USB-compliant peripheral device, such as a portable USB flash memory module. One drawback to the use of KVM device for USB/VGA switching, however, is that it requires additional control signal circuitry to be added to the KVM device, which would considerably increase the number of pins and hardware complexity on the KVM device, and therefore is quite costly and laborious to implement.

One solution to the foregoing problem is to install a specially-designed logic chip in each of the server modules in the blade server that is capable of converting the output VGA signal from each server module into a serial form. One drawback to this solution, however, is that this kind of logic chip is quite costly to purchase and also requires the addition of extra control signal circuitry, and therefore is nonetheless quite costly and laborious to implement.

### SUMMARY OF THE INVENTION

It is therefore an objective of this invention to provide a multiplexed computer peripheral connection switching interface which allows the multiple server modules in a blade server to share a group of peripheral devices without having to utilize a costly KVM switch.

It is another objective of this invention to provide a multiplexed computer peripheral connection switching interface which allows the multiple server modules in a blade server to share a group of peripheral devices without having to use additional control signal circuitry.

It is still another objective of this invention to provide a multiplexed computer peripheral connection switching interface which provides a more cost-effective and convenient solution for the multiple server modules in a blade server to share a group of peripheral devices.

The multiplexed computer peripheral connection switching interface according to the invention is designed for use in conjunction with a clustered computer system that is equipped with a number of independent data processing units, such as a blade server with multiple server modules, for the multiple server modules in the blade server to share a group of peripheral devices, including, for example, a keyboard, a mouse, a display unit, and a data storage unit (such as a portable flash memory module).

The multiplexed computer peripheral connection switching interface according to the invention is characterized by the use of the existing BMC (Baseboard Management Controller) management control module (which is a standard module in most blade servers) for control of the linking between a user-specified server module and a selected one of the peripheral devices, allowing any one of the peripheral devices to be selectively linked to any one of the multiple server modules in the blade server. This feature allows the multiple server modules in a blade server to share a group of peripheral devices without having to utilize a costly KVM (keyboard/video/mouse) switch or install additional control signal circuitry as in the case of prior art, allowing the invention to be more cost-effective and convenient to implement than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application architecture of the multiplexed computer peripheral connection switching interface according to the invention when used in conjunction with a blade server; and

FIG. 2 is a schematic diagram showing the modularized component model of the multiplexed computer peripheral connection switching interface of the invention.

### DETAILED DESCRIPTION OF PREFERRED EMBODIMENTS

The multiplexed computer peripheral connection switching interface according to the invention is disclosed in full details by way of preferred embodiments in the following with reference to the accompanying drawings.

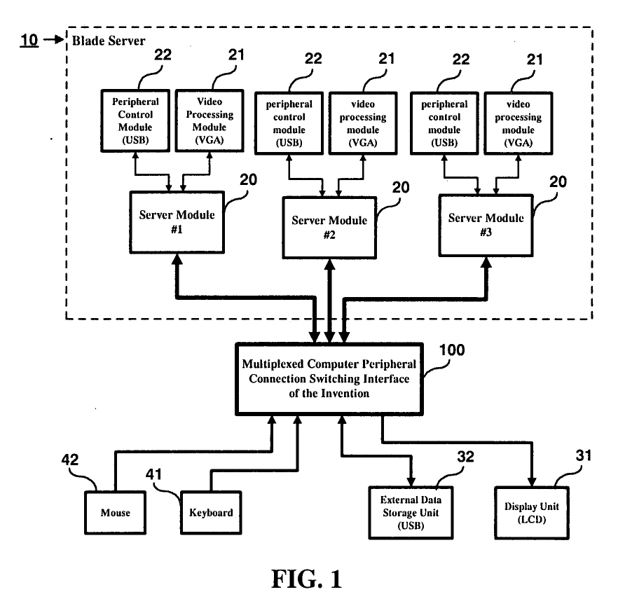

FIG. 1 is a schematic diagram showing the application architecture of the multiplexed computer peripheral connection switching interface according to the invention 100. As shown, in practical application, the multiplexed computer peripheral connection switching interface of the invention 100 is coupled to a clustered computer system (such as a blade server 10) that is equipped with a number of independent data processing units (such as a number of server modules 20 in the blade server 10), with each server module 20 being equipped with a video processing module 21 and a peripheral control module 22 where each video processing module 21 is for example a VGA (Video Graphics Array) module while each peripheral control module 22 is for example a USB (Universal Serial Bus) control module. In the embodiment of FIG. 1, for example, three server modules (#1, #2, #3) 20 are used for demonstrative purpose; but in practice, the number of the server modules in the blade server is unrestricted). Functionally, the multiplexed computer peripheral connection switching interface of the invention 100 is designed for the purpose of allowing the multiple server modules 20 in the blade server 10 to share an external set of peripheral devices, including, for example, a display unit 31, a USB data storage unit 32, a keyboard 41, and a mouse 42.

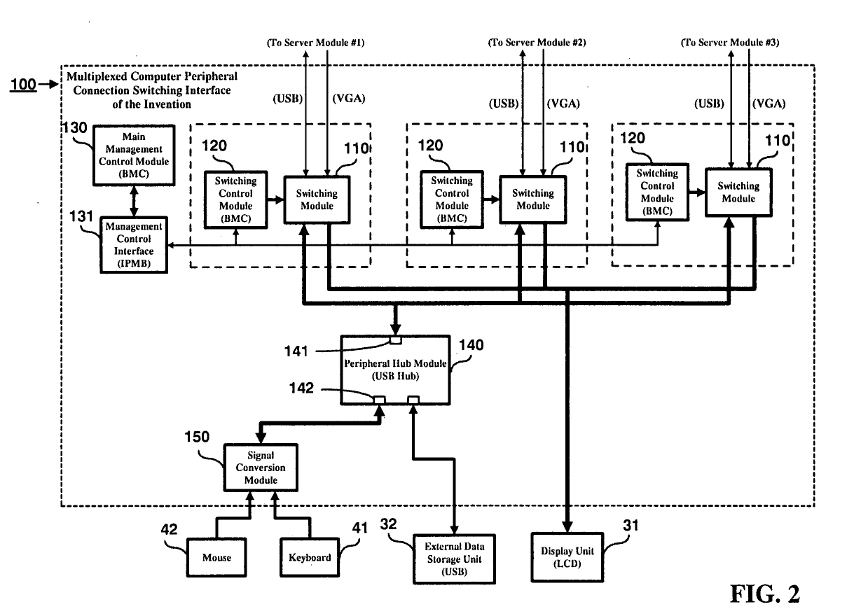

As shown in FIG. 2, the modularized component model of the multiplexed computer peripheral connection switching interface of the invention 100 comprises: (a) a plurality of switching modules 110; (b) a plurality of switching control modules 120; (c) a main management control module 130; (d) a peripheral hub module 140; and (e) a signal conversion module 150.

The switching modules 110 are each, for example, an analog-type switching device, and which are respectively coupled to one of the multiple server modules 20 in the blade server 10 for switching between the connection to the VGA video processing module 21 and the connection to the USB peripheral control module 22 in the associated one of the server modules 20 under control of one of the switching control modules 120 for selectively linking each VGA video processing module 21 and each USB peripheral control module 22 to either the peripheral hub module 140 or directly the externally-connected display unit 31.

The switching control modules 120 are each, for example, a built-in functional unit in an existing BMC (Baseboard Management Controller) module in the blade server 10, and which are respectively connected to one of the switching modules 110 and together linked via a management control interface 131 to the main management control module 130 for control by the main management control module 130 to control each of the switching modules 110 in the VGA/USB switching actions.

The main management control module 130 is, for example, a BMC (Baseboard Management Controller) module, and which is linked via a special management control interface 131, such as an IPMB (Intelligent Platform Management Bus) compliant interface to each of the switching control modules 120 for controlling each of the switching control modules 120 in the switching control of the associated one of the switching modules 110 to perform VGA/USB switching between the VGA video processing module 21 and the USB peripheral control module 22. Since IPMB is a well-known server interface standard in the information industry, detailed description thereof will not be given in this specification.

The peripheral hub module 140 is, for example, a USB hub, which has a first connecting side 141 and a second connecting side 142, wherein the first connecting side 141 is connected to each of the switching modules 110 for linking via each switching modules 110 to each USB peripheral control module 22, while the second connecting side 142 is connected to both the signal conversion module 150 and the externally-connected USB data storage unit 32.

The signal conversion module 150 is connected internally to the second connecting side 142 of the peripheral hub module 140, and externally to a second group of peripheral devices, including, for example, a keyboard 41 and a mouse 42, for converting the output signals from the keyboard 41 and the mouse 42 into a format that is acceptable by the USB peripheral control module 22 (i.e., into USB signal format) so as to allow the output signals from the keyboard 41 and the mouse 42 to be transmitted via the peripheral hub module 140 and each switching modules 110 to the USB peripheral control module 22, allowing the keyboard 41 and the mouse 42 to input data to a specified one of the server modules 20.

In practical application, the user (i.e., network system management personnel) can utilize the multiplexed computer peripheral connection switching interface of the invention 100 to let the multiple server modules 20 in the blade server 10 to share the same group of peripheral devices, including, for example, a display unit 31, a USB data storage unit 32, a keyboard 41, and a mouse 42.

Referring together to FIG. 1 and FIG. 2, when the user wants to link a particular one of the server modules 20 to the display unit 31, the BMC-based main management control module 130 will respond to this request by issuing related commands via the IPMB management control interface 131 to the associated one of the switching control modules 120, for activating the associated switching control module 120 to control the associated one of the switching modules 110 to selectively link the display unit 31 to the VGA video processing module 21 in the user-specified one of the server modules 20. When the link is established, it allows the VGA video processing module 21 to send VGA signals via the switching module 110 to the externally-connected display unit 31.

When the user wants to link a particular one of the server modules 20 to the USB data storage unit 32, the BMC-based main management control module 130 will respond to this request by issuing related commands via the IPMB management control interface 131 to the associated switching control module 120, for activating the switching control module 120 to control the associated switching module 110 to selectively link the peripheral hub module 140 to the USB peripheral control module 22. When the link is established, it allows the USB peripheral control module 22 in the user-specified server module 20 to gain access to the externally-connected USB data storage unit 32 successively via the switching modules 110 and the peripheral hub module 140 for storing data into or fetching data from the USB data storage unit 32.

When the user wants to link a particular one of the server modules 20 to the keyboard 41, the BMC-based main management control module 130 will respond to this request by issuing related commands via the IPMB management control interface 131 to the associated switching control module 120, for activating the switching control module 120 to control the associated switching module 110 to selectively link the peripheral hub module 140 to the USB peripheral control module 22. When the link is established, it allows the USB peripheral control module 22 in the user-specified server module 20 to receive the input data from the keyboard 41 successively via the signal conversion module 150, the peripheral hub module 140, and the associated switching module 110.

When the user wants to link a particular one of the server modules 20 to the mouse 42, the BMC-based main management control module 130 will respond to this request by issuing related commands via the IPMB management control interface 131 to the associated switching control module 120, for activating the switching control module 120 to control the associated switching module 110 to selectively link the peripheral hub module 140 to the USB peripheral control module 22 in the user-specified server module 20. When the link is established, it allows the USB peripheral control module 22 in the user-specified server module 20 to receive the input signals from the mouse 42 successively via the signal conversion module 150, the peripheral hub module 140, and the associated switching module 110.

In conclusion, the invention provides a multiplexed computer peripheral connection switching interface which is designed for use in conjunction with a clustered computer system that is equipped with a number of independent data processing units, such as a blade server with multiple server modules, for the multiple server modules in the blade server to share an external set of peripheral devices; and which is characterized by the use of the existing BMC (Baseboard Management Controller) management control module (which is a standard module in most blade servers) for control of the linking between a user-specified server module and a selected one of the peripheral devices, allowing any one of the peripheral devices to be selectively linked to any one of the multiple server modules in the blade server. This feature allows the multiple server modules in a blade server to share a group of peripheral devices without having to utilize a costly KVM (keyboard/video/mouse) switch or install additional control signal circuitry as in the case of prior art, allowing the invention to be more cost-effective and convenient to implement than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A multiplexed computer peripheral connection switching interface for use with a clustered computer system that is equipped with a number of independent data processing units each of which is equipped with at least one video processing module and a peripheral control module, for the purpose of allowing the multiple data processing units in the clustered computer system to share an external set of peripheral devices;
the multiplexed computer peripheral connection switching interface comprising:
a plurality of switching modules, which are respectively associated with one of the multiple data processing units in the clustered computer system, and each of which is capable of switching between the connection to the video processing module and the connection to the peripheral control module in the associated data processing unit;
a plurality of switching control modules, which are respectively connected to one of the switching modules to control each of the switching modules to switch between the connection to the video processing module and the connection to the peripheral control module in the associated data processing unit;
a main management control module, which is linked via a management control interface to each of the switching control modules for management control of the switching control modules to control the switching actions performed by the switching modules;
a peripheral hub module, which has a first connecting side and a second connecting side wherein the first connecting side is connected to each of the switching modules for linking via each of the switching modules to each peripheral control module; and
a signal conversion module, which is connected externally to a group of peripheral devices and internally to the second connecting side of the peripheral hub module for linking the peripheral devices via the peripheral hub module and the switching modules to each peripheral control module.

2. The multiplexed computer peripheral connection switching interface of claim 1, wherein the clustered computer system is a blade server.

3. The multiplexed computer peripheral connection switching interface of claim 1, wherein the switching modules are each an analog-type switching device.

4. The multiplexed computer peripheral connection switching interface of claim 1, wherein the main management control module is a BMC (Baseboard Management Controller) module.

5. The multiplexed computer peripheral connection switching interface of claim 1, wherein the switching control modules are each a built-in functional unit in a BMC (Baseboard Management Controller) module.

6. The multiplexed computer peripheral connection switching interface of claim 1, wherein the management control interface is an IPMB (Intelligent Platform Management Bus) compliant interface.

7. The multiplexed computer peripheral connection switching interface of claim 1, wherein each video processing module is a VGA (Video Graphics Array) module, and each peripheral control module is a USB (Universal Serial Bus) control module.

8. The multiplexed computer peripheral connection switching interface of claim 1, wherein the peripheral devices includes a first subgroup of peripheral devices including a display unit and an external data storage unit, and a second group of peripheral devices including a keyboard and a mouse.
